(19) United States
(12) Patent Application Publication
(10) Pub. No.: US 2005/0180402 A1
(43) Pub. Date: Aug. 18, 2005

(54) Method for improving the quality of a voice transmission via an air interface

(75) Inventor: Jurgen Heitmann, Neuried (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/062,300

(22) Filed: Feb. 18, 2005

(30) Foreign Application Priority Data
Feb. 18, 2004 (DE) 10 2004 007 976.5

(51) Int. Cl. H04L 12/66

(52) U.S. Cl. 370/352

(57) ABSTRACT

According to the invention, to improve the quality of a voice transmission via an air interface (LS) provided for voice data and general data transmission (DAT), it is first verified whether the data (DA, DB, DAT) to be transmitted via the air interface (LS) is voice data (DA, DB). If so, a specific forward error correction method for voice transmission is enabled, which is applied to the voice data (DA, DB) in the context of its transmission via the air interface (LS).

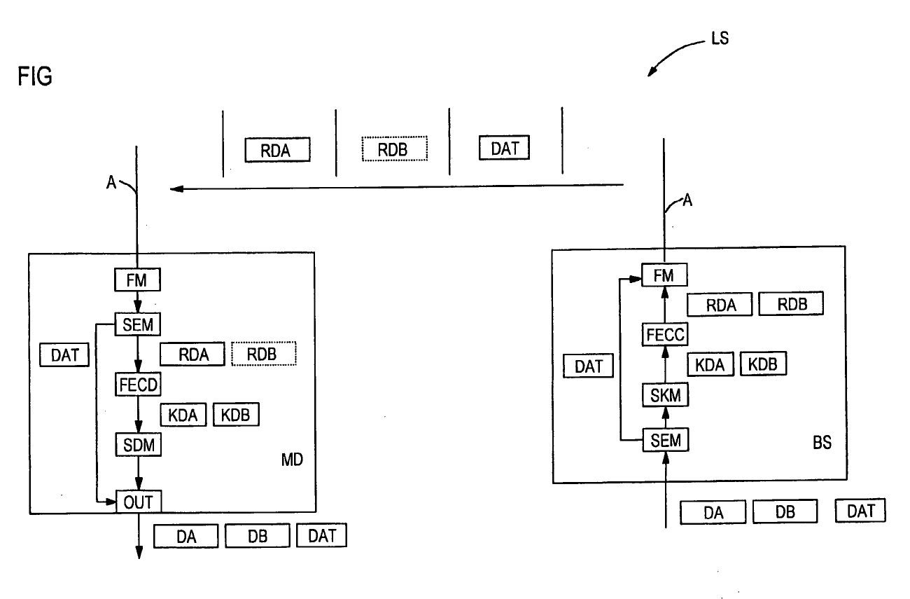

### CROSS REFERENCE TO RELATED APPLICATIONS

This application claims priority to the German application No. 10 2004 007 976.5, filed Feb. 18, 2004 and which is incorporated by reference herein in its entirety.

### FIELD OF INVENTION

The invention relates to a method for improving the quality of a voice transmission via an air interface.

### BACKGROUND OF INVENTION

Modern communication systems increasingly feature mobile communication devices, in particular mobile voice communication devices. In the case of a wireless voice transmission voice signals to be transmitted in real time are generally digitized and transmitted in the form of data packets via an air interface. In the field of bi-directional wireless voice communication different transmission standards, such as DECT (Digital European Cordless Telecommunications) or GSM (Global System for Mobile Communications) have been established. There is also currently a trend towards the use of so-called WLANs (Wireless Local Area Networks), which are actually provided for data communication, for wireless voice transmission as well.

The wireless transmission methods mentioned use transmission frequencies of around one to several gigahertz. This corresponds to transmission wavelengths of approximately 30 cm and below.

In environments where conditions are problematic for radio with a large number of surfaces reflecting the radio waves, e.g. in or between buildings, multiple reflection of radio waves results in multipath reception and radio wave overlay. This frequently causes destructive interference or oscillation nodes, which can lead to signal extinction at some points in a space. A mobile terminal with an established voice connection, which is moved by its user in an environment with such problematic radio conditions, frequently passes through such points where the signal is extinguished or at least attenuated. This is generally perceived during a call by clicking noises or transmission breaks, which the user generally finds extremely disruptive and which have a significantly adverse effect on the perceived voice quality.

To reduce such impairment in narrow-band voice transmission systems, such as GSM, so-called equalizers are used to suppress multipath reception. In the case of radio transmissions with a higher bandwidth requirement, e.g. DECT or WLAN systems, such an equalizer would however incur significantly higher set-up costs. Also an equalizer would not improve the reception situation in the case of local signal extinction.

A further option for preventing reception impairment in environments with problematic radio conditions is to use at least two spatially separated antennae, if necessary with separate receivers. During operation the system switches to the antenna or receiver respectively, which has the signal with the best signal-to-noise ratio. This method is frequently referred to as antenna diversity or space diversity. As this requires an additional antenna and generally an additional receiver circuit, it is however relatively expensive to set up.

### SUMMARY OF INVENTION

The object of the present invention is to specify a method for improving the quality of a voice-transmission via an air interface provided for voice data and general data transmission, which can be set up at low cost.

This object is achieved by the claims.

According to the invention, to improve the quality of a voice transmission via an air interface provided for voice data and general data transmission, it is first verified whether data to be transmitted via the air interface is voice data. If so, a specific forward error correction method for voice transmission is enabled, which is applied to the voice data in the context of its transmission via the air interface. The-air interface can hereby be set up for example according to the DECT or GSM standard or according to a WLAN standard such as IEEE-802.11.

By enabling a specific forward error correction method for voice transmission it is possible to reduce the frequency of transmission errors significantly, in particular with moving users, and thus greatly improve voice transmission quality. The specific forward error correction method for voice transmission is characterized in particular by a good real time response. Other error correction methods frequently used with general data do not generally have an acceptable real time response for voice transmissions.

The voice data verification and the enabling on that basis of the specific forward error correction method for voice transmission makes it possible to achieve a high level of voice transmission quality without having an adverse effect on the efficient transmission of general data, even with air interfaces actually provided for general data transmissions, e.g. WLAN air interfaces. The decision whether data to be transmitted is voice data can thereby be made for example using signaling information assigned to the data, priority information or quality of service data or on the basis of the packet size.

With the method according to the invention, voice transmission becomes less sensitive to short-term radio interference, caused for example by ignition sparks, and in particular to the short-term passage of a receiver antenna of the air interface moving with a user through areas with local signal extinction (oscillation nodes). It is thus possible, even in environments with problematic radio conditions, to ensure a high level of voice transmission quality without requiring additional antennae or receiver circuits.

Advantageous embodiments and developments of the invention are specified in the dependent Claims.

According to one advantageous embodiment of the invention, the forward error correction method is based on a spread convolutional code, preferably with an information verification step ratio of 1:1. Such a forward error correction method is described for example in the technical publication “Fernschreib- und Datenübertragung über Kurzwelle” (Short-wave Telex and Data Transmission), by Lothar Wiesner, published by Siemens AG, Berlin and Munich, 1975, page 139. The use of a spread convolutional code makes it possible to compensate for short-term transmission interference in particular and to reconstruct incorrectly transmitted voice data. The transmission delay due to coding and decoding the voice data is relatively short with spread convolutional codes, resulting in a good real time response.

Provision can also be made for an additional transmission channel of the air interface to be reserved for the transmission of redundancy data added to the voice data in the context of the forward error correction method. This allows the influence of channel-specific interference to be reduced. In the case of a DECT air interface, it is possible for example for a voice connection with a transmission rate of 32 kBit/sec to be distributed to at least two data channels with a total of at least 64 kBit/sec. In the case of a WLAN air interface, it is possible for a voice connection to be distributed accordingly to at least two logical channels or logical connections.

It is preferably possible with the forward error correction method to enable a voice compression method, e.g. according to the ITU-T recommendation G.729 for transmitter-side compression and receiver-side decompression of voice data. The voice compression method is preferably adapted to the requirements of real time voice transmission and configured such that a continuous input voice data stream is converted to a continuous output voice data stream with a slower data rate with the shortest possible delay. The compressed voice data, which is also provided with redundancy data in the context of the forward error correction method, can then be transmitted within a single transmission channel of the air interface due to the reduced transmission rate achieved with the compression. This is advantageous in that no additional transmission channel of the air interface is reserved. Thus for example in the case of a transmission according to the DECT standard, instead of the ADPCM voice compression method (ADPCM: Adaptive Differential Pulse Code Modulation) used there, a different voice compression method, e.g. according to the G.729 standard, can be used, which converts to a lower data rate than the ADPCM method. Voice compression according to the G.729 standard converts to a data rate of 8 kBit/sec, so the transmission rate of 32 kBit/sec of a single transmission channel of the DECT air interface is adequate for the transmission of voice data with redundancy data.

An exemplary embodiment of the invention is described in more detail below with reference to the drawing.

### BRIEF DESCRIPTION OF THE DRAWING

The sole FIGURE shows a schematic diagram of a base station and a mobile terminal device, between which a wireless voice connection is established.

### DETAILED DESCRIPTION OF INVENTION

The FIGURE shows a schematic diagram of a base station BS and a mobile terminal device MD. The base station BS can for example be set up according to the DECT or GSM standard or as a so-called WLAN access point. The mobile terminal device MD can for example be a cordless telephone according to the DECT standard, a mobile telephone according to the GSM standard or another mobile terminal, e.g. a laptop or PDA (Personal Digital Assistant), with a WLAN interface.

The mobile terminal device MD is linked via an air interface LS to the base station BS and it should be assumed that there is a wireless real time voice connection. The air interface LS is shown in the FIGURE by a horizontal arrow and can be configured for example according to the DECT or GSM standard or according to an IEEE-802.11 WLAN standard. The air interface LS preferably has a plurality of transmission channels for voice or data transmission, so that a plurality of logical connections can be set up. The FIGURE only shows one of these transmission channels for purposes of clarity.

To establish the air interface LS, the mobile terminal device MD and the base station BS each have a radio module FM with a radio antenna A.

The base station BS also has a forward error correction coder FECC linked to its radio module FM, a voice compression module SKM linked to said coder FECC and a voice recognition module SEM linked to the voice compression module SKM.

The mobile terminal device MD correspondingly has a voice recognition module SEM linked to its radio module FM, a forward error correction decoder FECD linked to said radio module FM and a voice decompression module SDM linked to said decoder FECD. The mobile terminal device MD has an output port OUT to output received data.

In the context of the voice connection the base station BS is sent voice data DA and DB and a data packet DAT containing no voice data, for transmission from the base station BS to the mobile terminal device MD via the air interface LS. The voice data DA and DB to be transmitted can for example be present as voice data packets according to the TCP/IP protocol family or as a voice data stream. Both TCP/IP voice data packets and also individual sections of a voice data stream are referred to below as voice data packets or data packets and are marked with the reference characters DA and DB.

In the present exemplary embodiment for the purpose of clarity only the transmission direction from the base station BS to the mobile terminal device MD is considered. The statements relating hereto however also apply analogically to the other transmission direction.

The data packets DA, DB and DAT to be transmitted are first routed to the voice recognition module SEM of the base station BS, which verifies whether or not they contain voice data. In the case of DECT systems this can be recognized for example from the signaling assigned to the data packets to be verified. In the present exemplary embodiment the voice data packets DA and DB are recognized as such and are therefore routed from the voice recognition module SEM to the voice compression module SKM. The data packet DAT containing no voice data is however forwarded directly from the voice recognition module SEM to the radio module FM of the base station BS. The voice compression module SKM compresses the voice data contained in the voice data packets DA and DB in a quasi-continuous manner and outputs compressed voice data packets KDA and KDB, which are forwarded to the forward error correction coder FECC. The respective compressed voice data packet KDA or KDB hereby contains the compressed voice data from the voice data packet DA or DB respectively.

The voice compression module SKM is preferably set up using a so-called Codec, e.g. according to the ITU-T recommendation G.729. Such a Codec converts to compressed voice data with a voice data rate of 8 kbit per second. In the case of DECT systems such a voice compression can be used instead of the ADPCM coding generally used there with a voice data rate of 32 kbit per second.

The forward error correction coder FECC is used to code a respective compressed voice data packet KDA or KDB by means of a forward error correction method, which is preferably based on a spread convolutional code with an information verification step ratio of 1:1, thereby adding redundancy data. The forward error correction coding converts a respective compressed voice data packet KDA or KDB to a voice data packet with redundancy data RDA or RDB, which is forwarded from the forward error correction coder FECC to the radio module FM.

The radio module FM transmits the voice data packets RDA and RDB and the data packet DAT transmitted from the voice recognition module SEM directly to the radio module FM via the air interface LF to the mobile terminal device MD.

In the present exemplary embodiment the data packets RDA, RDB and DAT are transmitted respectively in a single radio frame of the air interface LS. The radio frames are shown in the FIGURE by vertical lines. The voice data packet RDA is transmitted in the radio frame sent first, the voice data packet RDB in the next radio frame and the data packet DAT in the third radio frame. It is necessary here for the original voice data packets DA and DB to be compressed such that the data packets RDA und RDB resulting after addition of the redundancy data can each be transmitted in a radio frame that is actually provided for a single uncompressed voice data packet without redundancy data. In this manner the voice data packets RDA and RDB can be transmitted in the same voice channel or within the same logical voice connection via the air interface LS.

Alternatively the voice data packets RDA and RDB or if necessary a redundancy element of these data packets to be predefined can be transmitted in different transmission channels or via different logical connections via the air interface LS. This alternative is particularly significant for WLAN systems, as with such systems previously compressed voice data often has to be transmitted, which permits no further compression. In such a case the addition of redundancy data could exceed the transmission capacity of a single transmission channel. According to one advantageous embodiment, provision can be made for the voice data to be transmitted also to be verified to establish whether it can be further compressed such that it can be transmitted together with added redundancy data within a single transmission channel. Depending on the result of the verification, the voice data can then be additionally compressed and transmitted in the same transmission channel or not be further compressed and be sent in different transmission channels.

For the present exemplary embodiment it should be assumed that the data packet RDB is corrupted by a transmission error during transmission via the air interface LS. Corruption is shown in the FIGURE by the broken line of the data packet RDB.

The data packets RDA, RDB and DAT are received by the radio module FM of the mobile terminal device D and forwarded to its voice recognition module SEM. The voice recognition module SEM verifies for each data packet received, whether it is a voice data packet. In the present exemplary embodiment the voice data packets RDA and RDB are identified as such and are transmitted from the voice recognition module SEM to the forward error correction decoder FECD. The data packet DAT is however identified by the voice recognition module SEM as a non-voice data packet and forwarded as such directly to the output port OUT, to be output from this.

The forward error correction decoder FECD converts the voice data packet RDA to the compressed voice data packet KDA and the corrupted voice data packet RDB to the compressed data packet KDB. In the present exemplary embodiment the redundancy data contained in the corrupted voice data packet RDB allows the compressed data packet KDB to be reconstructed without error. In practice the frequency of transmission errors can typically be reduced by a factor of 10 to 100 by the inventive application of the forward error correction method.

The compressed voice data packets KDA and KDB are then transmitted from the forward error correction decoder FECD to the voice decompression module SDM, to be converted by this to the uncompressed voice data packets DA and DB, which are finally output via the output port OUT.

1-5. (canceled)

6. A method for improving quality of a data transmission via an air interface provided for voice data and non-voice data transmission, the method comprising:
determining whether the data to be transmitted include voice data;
applying a forward error correction method to the voice data; and
transmitting the voice data and the non-voice data via the air interface.

7. The method according to claim 6, wherein the forward error correction method is based on a spread convolutional code.

8. The method according to claim 7, wherein the convolutional code has an information verification step ratio of 1:1.

9. The method according to claim 6, wherein the voice data include redundancy data generated by the forward error correction method, and wherein the redundancy data are transmitted from the voice data and non-voice data via a separate channel of the air interface.

10. The method according to claim 7, wherein the voice data include redundancy data generated by the forward error correction method, and wherein the redundancy data are transmitted from the voice data and non-voice data via a separate channel of the air interface.

11. The method according to claim 8, wherein the voice data include redundancy data generated by the forward error correction method, and wherein the redundancy data are transmitted from the voice data and non-voice data via a separate channel of the air interface.

12. The method according to claim 6, further comprising:
applying a voice compression method to the voice data, the voice compression method including a transmitter-side compression and a receiver-side decompression of the voice data.

13. The method according to claim 7, further comprising:
applying a voice compression method to the voice data, the voice compression method including a transmitter-side compression and a receiver-side decompression of the voice data.

14. The method according to claim 8, further comprising:
applying a voice compression method to the voice data, the voice compression method including a transmitter-side compression and a receiver-side decompression of the voice data.

15. The method according to claim 9, further comprising:
applying a voice compression method to the voice data, the voice compression method including a transmitter-side compression and a receiver-side decompression of the voice data.

16. The method according to claim 12, wherein the compressed voice data and redundancy data generated by the forward error correction method and added to the voice data are transmitted via one transmission channel of the air interface.

17. The method according to claim 13, wherein the compressed voice data and redundancy data generated by the forward error correction method and added to the voice data are transmitted via one transmission channel of the air interface.

18. The method according to claim 14, wherein the compressed voice data and redundancy data generated by the forward error correction method and added to the voice data are transmitted via one transmission channel of the air interface.

19. The method according to claim 15, wherein the compressed voice data and redundancy data generated by the forward error correction method and added to the voice data are transmitted via one transmission channel of the air interface.

20. The method according to claim 6, wherein the forward error correction method is specific to voice data.
